(19) United States
(12) Patent Application Publication
(10) Pub. No.: US 2020/0153364 A1
(43) Pub. Date: May 14, 2020

(54) HVAC HYBRID BLOWER MOTOR SOFT START

(71) Applicant: Carrier Corporation, Palm Beach Gardens, FL (US)

(72) Inventor: Qi Guo, Boston, MA (US)

(21) Appl. No.: 16/191,015

(22) Filed: Nov. 14, 2018

(51) Int. Cl. H02P 1/04; F24F 11/74; H02P 1/18

(52) U.S. Cl. CPC H02P 1/04; F25B 2600/11; H02P 1/18; F24F 11/74

(57) ABSTRACT

A method for soft start of a motor in a heating, ventilation, and cooling (HVAC) system. The method includes operably connecting a first switching device with the motor; the first switching device operably connected to a power source and configured to direct power from a DC power source to the motor, and operably connecting a second switching device with the motor, the second switching device operably connected to a power source and configured to direct power from the DC power source to the motor. The method also includes receiving, by a controller, a request to engage the motor associated with an operation of the HVAC system, commanding the first switching device with a first pulse width modulation signal for a first selected duration, while ensuring the second switching device is disengaged, and after the first selected duration, enabling the second switching device and disengaging the first switching device.

### FIELD OF INVENTION

Embodiments relate generally to air flow control in an HVAC system and, more particularly, to a system and method for improved blower and air flow control algorithms in an air handling unit of an HVAC system that provides for smoother and quieter startup of a blower motor.

### DESCRIPTION OF RELATED ART

Modern structures, and vehicles such as office buildings and residences, manufactured homes, and recreational vehicles utilize heating, ventilation, and cooling (HVAC) systems having controllers that allow users to control the environmental conditions within these structures. These controllers have evolved over time from simple temperature based controllers to more advanced programmable controllers, which allow users to program a schedule of temperature set points in one or more environmental control zones for a fixed number of time periods as well as to control the humidity in the control zones, or other similar conditions. Typically, these HVAC systems use an air handler connected to ducts to delivered conditioned air to an interior space. These ducts provide a path for air to be drawn from the conditioned space and then returned to the air handler. These duct systems vary in shape, cross section and length to serve the design constraints of a structure. The air handler includes a motor and a fan to move the air through the ducts, conditioning equipment and the space. These air handlers are designed to accommodate the wide range of loading represented by the various duct system designs used in these modern structures.

Some current air handlers use electronically commutated motors (ECM) with internal compensation algorithms that improve the blower system performance over induction motor driven models. The algorithms in these ECM driven blowers are capable of varying power output to provide improved blower performance to meet loading requirements over most of the air handler's operating envelope of mass flow versus static pressure loading. However, for some systems with less sophisticated and less expensive motors, controlling blower motors and their performance is more limited and applications to achieve a desired motor speed, and airflow may not be readily available.

Furthermore, loud noise caused instantaneous starting of a blower motor may be extremely loud, and other conditions may cause loud motor and air handler system noise, and thus be undesirable in noise-sensitive applications, such as HVAC equipment installed near spaces typically occupied by people (such as in a recreational vehicle or a mobile home).

### BRIEF SUMMARY

Described herein in an embodiment is a method for soft start of a motor in a heating, ventilation, and cooling (HVAC) system. The method includes operably connecting a first switching device with the motor, the first switching device operably connected to a power source and configured to direct power from a DC power source to the motor, and operably connecting a second switching device with the motor, the second switching device operably connected to a power source and configured to direct power from the DC power source to the motor. The method also includes receiving, by a controller, a request to engage the motor associated with an operation of the HVAC system, commanding the first switching device with a first pulse width modulation(PWM)signal for a first selected duration, while ensuring the second switching device is disengaged, and after the first selected duration, enabling the second switching device and disengaging the first switching device.

In addition to one or more of the features described above, or as an alternative, further embodiments of the method may include receiving a request to disengage the motor and blower, disengaging the second switching device, and commanding the first switching device with a second PWM signal for a second selected duration.

In addition to one or more of the features described above, or as an alternative, further embodiments of the method may include that the second PWM signal is operable to cause the first switching device to decelerate the motor over the second selected duration.

In addition to one or more of the features described above, or as an alternative, further embodiments of the method may include that the first selected duration is based on at least one of an amount of power dissipated in the first switching device, a thermal properties of the first switching device, and an operating characteristic of the motor.

In addition to one or more of the features described above, or as an alternative, further embodiments of the method may include that the first selected duration is selected to ensure start-up of the motor without exceeding the thermal properties of the first switching device for the power dissipated in the first switching device.

In addition to one or more of the features described above, or as an alternative, further embodiments of the method may include that the first PWM signal is operable to cause the first switching device to accelerate the motor over the selected duration.

In addition to one or more of the features described above, or as an alternative, further embodiments of the method may include that the request is based on a call for heating or cooling in the HVAC system.

In addition to one or more of the features described above, or as an alternative, further embodiments of the method may include that the first selected duration is based on at least one of an amount of power dissipated in the first switching device, a thermal properties of the first switching device, and an operating characteristic of the motor.

In addition to one or more of the features described above, or as an alternative, further embodiments of the method may include that the first switching device is a semiconductor device and the second switching device is an electromechanical device.

In addition to one or more of the features described above, or as an alternative, further embodiments of the method may include that the first switching device is a MOSFET and the second switching device is a relay.

Also described herein in another embodiment is a system for soft start of a blower and a motor in a heating, ventilation, and cooling (HVAC) system. The system includes a DC power source, an air handler including a blower and a motor operably coupled to a duct network as part of the HVAC system. The system also includes a first switching device in operable communication with the motor; the first switching device operably connected to the DC power source and configured to direct power from the DC power source to the motor, a second switching device operably connected with the motor, the second switching device operably connected to a power source and configured to direct DC power from the DC power source to the motor, and a controller in operable communication with the motor, the first switching device and the second switching device, the controller configured to execute a method for soft starting of the motor. The method includes receiving a request to engage the motor and blower, commanding the first switching device with a first pulse width modulation signal for a first selected duration, while ensuring the second switching device is disengaged, and after the first selected duration, enabling the second switching device and disengaging the first switching device.

In addition to one or more of the features described above, or as an alternative, further embodiments of the system may include that the controller is also configured to receive a request to disengage the motor and blower associated with the operation of the HVAC system, disengage the second switching device, and commanding the first switching device with a second PWM signal for a second selected duration.

In addition to one or more of the features described above, or as an alternative, further embodiments of the system may include that the second PWM signal is operable to cause the first switching device to decelerate the motor over the second selected duration.

In addition to one or more of the features described above, or as an alternative, further embodiments of the system may include that the first selected duration is based on at least one of an amount of power dissipated in the first switching device, a thermal properties of the first switching device, and an operating characteristic of the motor.

In addition to one or more of the features described above, or as an alternative, further embodiments of the system may include that the first selected duration is selected to ensure start-up of the motor without exceeding the thermal properties of the first switching device for the power dissipated in the first switching device.

In addition to one or more of the features described above, or as an alternative, further embodiments of the system may include that. wherein the first PWM signal is operable to cause the first switching device to accelerate the motor over the selected duration.

In addition to one or more of the features described above, or as an alternative, further embodiments of the system may include that the request is based on a call for heating or cooling in the HVAC system.

In addition to one or more of the features described above, or as an alternative, further embodiments of the system may include that the first selected duration is based on at least one of an amount of power dissipated in the first switching device, a thermal properties of the first switching device, and an operating characteristic of the motor.

In addition to one or more of the features described above, or as an alternative, further embodiments of the system may include that the first switching device is a semiconductor device and the second switching device is at least one of a semiconductor device and an electromechanical device.

In addition to one or more of the features described above, or as an alternative, further embodiments of the system may include that the first switching device is a MOSFET and the second switching device is a relay.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates a schematic view of an HVAC system including an air handler, system control unit, an air handler control unit, and a user device for implementing the method in accordance with an embodiment;

FIG. 2 illustrates a block diagram view of a portion of an HVAC system including a power source, air handler controller, system control unit, and motor for implementing the method in accordance with an embodiment; and

FIG. 3 is a flow diagram illustrating a method controlling an air handler including a blower and a motor to improved starting performance in a heating, ventilation, and cooling (HVAC) system in accordance with an embodiment.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended. The following description is merely illustrative in nature and is not intended to limit the present disclosure, its application or uses. It should be understood that throughout the drawings, corresponding reference numerals indicate like or corresponding parts and features. As used herein, the term controller refers to processing circuitry that may include an application specific integrated circuit (ASIC), an electronic circuit, an electronic processor (shared, dedicated, or group) and memory that executes one or more software or firmware programs, a combinational logic circuit, and/or other suitable interfaces and components that provide the described functionality.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection”.

Embodiments of an HVAC system include a soft starting technique for applications employing a blower motor. A controller operates the blower motor with a pulse width modulation (PWM) control according to commanded scheme and duration. The method is used to reduce motor and air handler system noise as a result of the instantaneous starting of blower motor under selected conditions. Specifically, the blower motor is operated with in increasing ramp in speed and then switched to direct excitation from a DC source. Advantageously, employing this method, the HVAC system can be operated with a soft and quieter starting scheme to reduce undesirable noise associated with the instantaneous starting of the blower motor.

It should be noted that in a typical ducted HVAC system, the air handler refers to the air handling unit that delivers conditioned air through air ducts to various parts of the conditioned space, e.g., a home, RV, office space and the like. In one typical system type, the air handler is also referred to as the fan coil unit and includes an blower and motor as well as refrigerant coil to provide cooling or heating in conjunction with an outside air conditioner or heat pump unit. The air handler may also optionally include a supplemental heat source such as an electric strip heater or a hydronic hot water coil. In another typical system, the air handler includes a gas furnace unit that also includes a gas burner and valve and employs the blower and motor, which is capable of delivering heat by combusting a fuel such as natural gas or propane. Embodiments apply to both types of air handler units and or gas furnace units are directed to air delivery capabilities, the power consumption of and noise generated by the blower motor. More specifically, the described embodiments may be employed with a gas furnace employing a gas burner and valve, particularly as employed in a recreational vehicle (RV). In addition a gas ignition controller may be employed and incorporate some or all of the functions described herein.

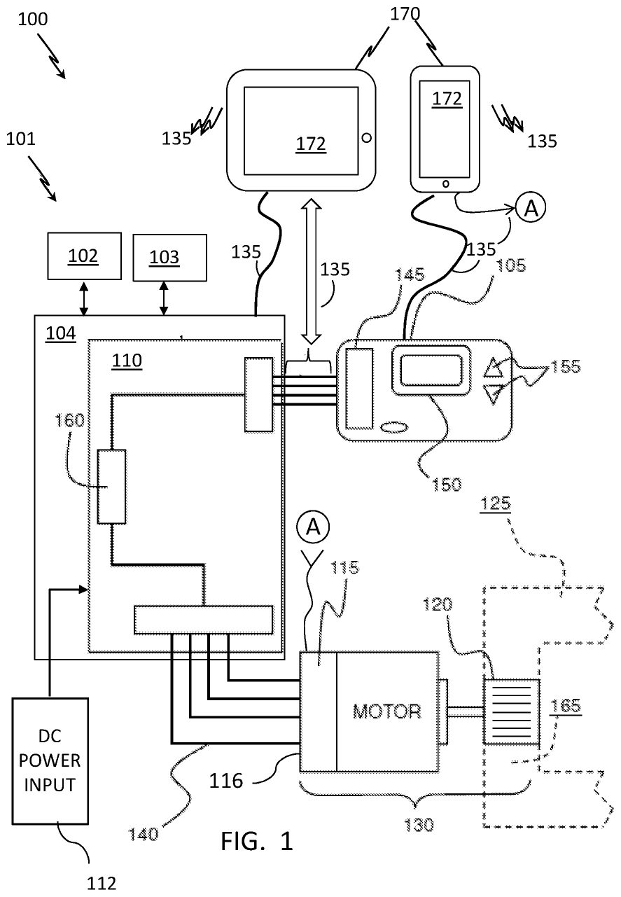

Referring now to the drawings, FIG. 1 illustrates a schematic view of an HVAC system 100. Particularly, the HVAC system 100 includes a system control unit 105, an gas ignition controller system shown generally as 101 that may include a gas valve 102, gas burner 103, burner ignition controller 104, an air handler/blower controller 110, and a blower system 130 (as part of an air handler) having a DC motor 115 and a blower 120 (for example, a centrifugal blower) connected to the duct system 125. In some embodiments, the gas ignition controller 101, burner ignition controller 105 and air handler/blower controller 110 may be integrated as a single unit and may be referred to interchangeably. The system control unit 105 may be a conventional thermostat with a display 150 indicating system status to a user and up/down selection buttons 155 to control selections for operation of the HVAC system 100. The system control unit 105 may include a processor and communications interface 145 for controlling the HVAC system and communicating with the other HVAC system 100 components, including, but not limited to via the communications bus 135. The system control unit 105 is in operative communication with the gas ignition controller 101, including the air handler controller 110 over system communication bus 135, which communicates signals between the system control unit 105 and the gas ignition controller 101.

In addition, user device 170 may communicate with the system 100 either via the system control unit 105, with the gas ignition controller 101, with the air handler controller 110, or directly to components such as the motor 115. The user device 170 may be any form of a mobile device (e.g., smart phone, smart watch, wearable technology, laptop, tablet, etc.). The user device 170 can include several types of devices, in one instance, even a fixed device, e.g. a keypad/touch screen affixed to a wall in a building corridor/lobby, and a user-owned device 170 such a smartphone. It should be appreciated that the first two (system control unit 105, with the gas ignition controller 101) are typically part of the system 100 infrastructure, while the third is typically owned and used by the service man, homeowner, and the like. The term “user device” 170 is used to denote all of these types of devices as may be employed by the user for the purposes of communication with the system 100. It should be appreciated that in some instances a user device 170 are proximate to the system 100, for example, a thermostat or system control unit 105, in others they are mobile. As a result of the bi-directional flow of information between the system control unit 105 and the gas ignition controller 101, and the user device 170, the algorithms described in exemplary embodiments may be implemented in either control unit 105, gas ignition controller 101, or the user device 170. Also, in some embodiments, certain aspects of the algorithms may be implemented in control unit 105 while other aspects may be implemented in gas ignition controller 101, or air handler controller 110, while other aspects may be implemented in the user device 170. For example, in an embodiment, algorithms for system communication, system and temperature control may be implemented in the system control unit 105, while algorithms specifically for controlling the gas valve 102 and burner 103 might be implemented by controller 104 and further, algorithms specifically for blower control may be implemented in the air handler controller 110, and yet algorithms for user preferences, user functions, commissioning, maintenance and diagnostics and the like might be implemented in the user device 170.

The user device 170 may include a mobile and/or personal device that is typically carried by a person, such as a phone, PDA, etc. The user device 170 may include a processor, memory, and communication module(s), as needed to facilitate operation and interfacing with the system 100. As described below, the processor can be any type or combination of computer processors, such as a microprocessor, microcontroller, digital signal processor, application specific integrated circuit, programmable logic device, and/or field programmable gate array. The memory can be a non-transitory computer readable storage medium tangibly embodied in the user device 170 including executable instructions stored therein, for instance, as firmware. The communication module may implement one or more communication protocols as described in further detail herein, and may include features to enable wired or wireless communication with external and/or remote devices separate from the user device 170. The user device 170 may further include a user interface 172 (e.g., a display screen, a microphone, speakers, input elements such as a keyboard or touch screen, etc.) as known in the art.

The user device 170, as well as other components of the system 100 including system control unit 105, with gas ignition controller 101 and/or the air handler controller 110, and motor 115 may communicate with one another, in accordance with the embodiments of the present disclosure, e.g., as shown in FIG. 1. For example, one or more user devices 170 and the gas ignition controller 101 or system control unit 105 may communicate with one another when proximate to one another (e.g., within a threshold distance). The user device 170 and any or all of system control unit 105, with the gas ignition controller 101, and motor 115 may communicate over one or more networks 135, (e.g., communication bus 135) that may be wired or wireless. Furthermore, as described herein, in some embodiments there may be no communication at all and the motor 115 merely receives power at a DC power input port 116.

Wireless communication networks 135 can include, but are not limited to, Wi-Fi, short-range radio (e.g., Bluetooth®), near-field infrared, cellular network, etc. In some embodiments, the system control unit 105 or gas ignition controller 101 may include, or be associated with (e.g., communicatively coupled to) one or more other networked building elements (not shown), such as computers, beacons, other system controllers, bridges, routers, network nodes, etc. The networked element may also communicate directly or indirectly with the user devices 170 using one or more communication protocols or standards (e.g., through the network 135). For example, the networked element may communicate with the user device 170 using near-field communications (NFC) and thus enable communication between the user device 170 and the system control unit 105 or any other components in the system 100. The network 135 may be any type of known communication network including, but not limited to, a wide area network (WAN), a local area network (LAN), a global network (e.g. Internet), a virtual private network (VPN), a cloud network, and an intranet. The network 135 may be implemented using a wireless network or any kind of physical network implementation known in the art. The user devices 170 and/or the networked devices may be coupled to the system control unit 105, the gas ignition controller 101, and/or motor 115 through multiple networks 135 (e.g., cellular and Internet) so that not all user devices 170 and/or the networked devices are coupled to the any given controller or component 105, 110, 115 through the same network 135. One or more of the user devices 170 and the system control unit 105 may be connected to the network 135 in a wireless fashion. In one non-limiting embodiment, the network 135 is the Internet and one or more of the user devices 170 execute a user interface application (e.g. a web browser, mobile app) to contact the including system control unit 105, the gas ignition controller 101, and/or motor 115 through the network 135.

In one embodiment, the user device 170 may include a computing system having a computer program stored on nonvolatile memory to execute instructions via a microprocessor related to aspects associated with the HVAC system 100. Also, the user device 170 includes a user input element 172 by which a user/installer may change the desired operating characteristics of the HVAC system 100, temperature set points, timing, schedules and the like. The user or app on user device 170 may also provide to gas ignition controller 101 certain specific aspects of the air handler installation such as, for example, the location or local altitude for operation of the air handler (e.g., based on location information available on user device 170), which may be used in the various algorithms; for mobile applications such as a recreational vehicle these may be updated periodically, such as on a set schedule, or on vehicle motor ignition or stop. It is to be appreciated that the system control unit 105 or gas ignition controller 101 implements aspects of an motor soft start control algorithm for the motor 115. It should be appreciated that while aspects of the algorithms described may be executed in the system control unit 105, in other embodiments, any of the above algorithms may also be executed in the gas ignition controller 101, or elsewhere without departing from the scope of the described embodiments.

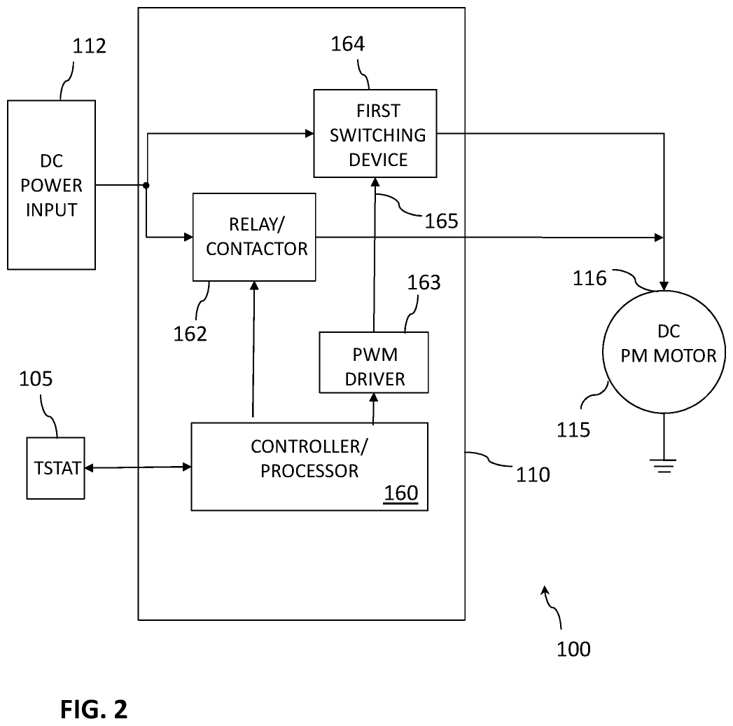

Turning now to FIG. 2 for further description of the HVAC system 100, FIG. 2 depicts a simplified block diagram of the HVAC system 100 and the gas ignition controller 101 operably connected to the motor 115 of the blower system 130 (as shown in FIG. 1). In an embodiment, a DC power supply 112 provides DC power to the gas ignition controller 101. The DC supply 112 can be based on conversion from grid AC power, separate generator, or battery based such as in an RV application. The gas ignition controller 101 and/or air handler controller 110 controls the application of the DC power to the motor 115. In an embodiment, the gas ignition controller 101 and/or air handler controller 110 provides at least two alternate paths for applying DC power from the DC power source 112 to the motor 115. The two paths are independent and independently controlled by the processor 160 of the gas ignition controller 101. In an embodiment, DC power is routed via a switching device 164 to the motor 115 when activated. In the second instance, DC power from the DC power source 112 is routed through a second switching device 162 to the motor 115 when activated. The second switching device may be a relay, contactor and the like that is either electromechanical or solid state but selected to carry the full current requirement of the motor 115. The gas ignition controller 101 includes a processor 160 and memory (not shown), which may store operational programs that when executed cause the gas ignition controller 101 to implement a method of soft starting the motor 115 as described herein.

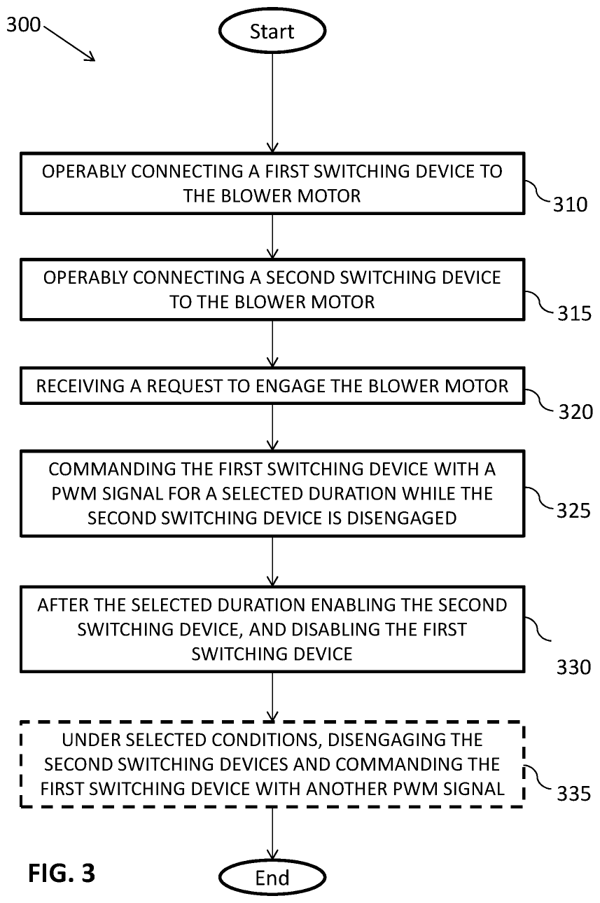

In an embodiment, the processor 160 executes a method 300 (shown in FIG. 3) as part of controlling the HVAC system 100. In operation, when the thermostat 105 (or another controller e.g., 170) calls for heating or cooling, and the blower is to be engaged, the gas ignition controller and/or air handler controller 110 commands the blower motor 115 to start as follows. In an embodiment, when starting the motor 115, the gas ignition controller and/or air handler controller 110 includes a pulse width modulation (PWM) function and driver 163 that applies a pulse width modulated command signal 165 to the switching device 164. The PWM command signal 165 causes the switching device 164 to activate for a selected duty cycle, and thereby applies the DC input power from the DC power source 112 to the DC motor 115 for the selected duty cycle. The PWM technique may be conventional in nature and designed to provide a smooth, low noise start up and speed ramp up for the motor 115. In an embodiment, the duty cycle of the command signal 165 and thereby that of the switching device 164 is increased over a selected duration to apply increasing duration voltage to the motor 115 and causing the speed of the motor 115 to increase. Simultaneously, when starting and stopping the motor 115, the relay/contactor 162 is commanded by the gas ignition controller 101 to be inactive, and as such provides no power from the DC power source 112 to the motor 115. In an embodiment the duty cycle of the PWM command signal 165, and thereby that of the switching device 164, is incremented to provide increasing commands for a smooth increase in the speed of the motor 115 over the selected duration. For example, in an embodiment the selected duration may be five seconds with the duty cycle increasing from 0% to 100%. It should be appreciated that while in the described embodiments a selected duration of five seconds, and a duty cycle range of 0%-100% is employed, such values are for illustration only. Various selected durations and duty cycle values and ranges are possible. Moreover, while the acceleration of the motor 115 is described as a ramp, it need not be linear, various ramps, curves functions and the like may also be possible.

Moreover, in another embodiment, the selected duration is chosen to be sufficiently long enough to enable smooth low noise acceleration of the motor 115, and yet short enough to avoid significant power dissipation and heating in the first switching device 164. Further, in yet another embodiment, the selected duration is chosen so that the power dissipated in the first switching device 164 over the selected duration is low enough that a heat sink is not required. More specifically, in an embodiment the first selected duration is selected to ensure smooth, low noise, start-up of the motor without exceeding the thermal properties (temperature ratings) of the first switching device 164 for the given power dissipated in the first switching device 164. In an embodiment, the first selected duration and/or the second selected duration is on the order of about 2-12 seconds including and duration therein. More specifically the selected duration is on the order of about 5-10 seconds including and duration therebetween. It should be appreciated that for various sizes of blower motors 115, the drive current necessarily varies, and can be as high as 15 Amperes for regular HVAC applications, including, but not limited to RV applications. When dealing with such a large current requirement, traditional designs have been implemented employing either only a first switching device 164 (e.g., PWM driven components) with a bulky external or onboard heat sink, or only a second switching device 162 (e.g., a relay or contactor). However, the PWM approach facilitates smooth starting and speed controls. When using the PWM driven circuit considerations need to be made in terms of the reliability of the switching device, heat generated, cost and size of a potential heat sink, associated assembly cost, and the additional circuit board space and volume needed in order to accommodate the heat sink. When using the relay only approach, while simpler, the loud noise generated by the blower starting is undesirable and results in customer complaints and dissatisfaction. Advantageously, by combining these two methods with seamless switching controlled by the gas ignition controller 101 between the first switching device 164 and the second switching device 162 the described embodiments achieve quieter blower motor 115 startup, while also addressing large, long duration operation power dissipation and thereby, avoiding large heat sinks. Avoiding continuous heat dissipation avoids the need for large heat sinks, which helps to reduce the total design cost.

In an embodiment, after the selected duration has passed the switching device 164 is no longer commanded by the gas ignition controller 101 and is deactivated and the relay/contactor 162 is activated by the gas ignition controller 101 to apply power from the DC power source 112 directly to the motor 115 for the remainder of time that there is a call within the HVAC system 100 for the blower 130 to be engaged.

In an embodiment, once the call within the HVAC system 100 for the blower 130 to be engaged has been satisfied, both the switching device 164 is no longer commanded and is deactivated and the relay/contactor 162 is deactivated, disconnecting or removing power from the motor 115 thus permitting it to coast to a stop.

Similarly, in yet another embodiment, when once the call within the HVAC system 100 for the blower 130 operation has been satisfied, a controlled deceleration or stop may be employed. In this embodiment, the relay/contactor 162 is deactivated, disconnecting or removing power from the motor 115, while the switching device 164 is once again commanded and activated, once again employing a the PWM function and driver 163 that applies a pulse width modulated command signal 165 to the switching device 164. Once again, in this embodiment, the PWM command signal 165 causes the switching device 164 to activate for a selected duty cycle, and thereby applies the DC input power from the DC power source 112 to the DC motor 115 for the selected duty cycle. The PWM technique is designed to provide a smooth, controlled deceleration for the motor 115. In an embodiment, the duty cycle of the command signal 165 and thereby that of the switching device 164 is decreased over a selected duration to apply decreasing duration voltage to the motor 115 and causing the speed of the motor 115 to reduce. In an embodiment the duty cycle of the PWM command signal 165, and there by that of the switching device 164 is decremented to provide decreasing commands for a smooth increase in the speed of the motor over the selected duration. For example, in an embodiment the selected duration may be five seconds with the duty cycle increasing from 100% to 0%. It should be appreciated that while in the described embodiments a selected duration of five seconds, and a duty cycle range of 100%-0% is employed, such values are for illustration only. Various selected durations and duty cycle values and ranges are possible.

FIG. 3 depicts a flow chart of the method 300 for soft startup of an HVAC system blower motor 115 in accordance with an embodiment. At process step 310, the communication is established between the gas ignition controller 101 and/or air handler controller 110 and the blower motor 115. The connection includes connecting a first switching device 164 to the blower motor 115 and connecting a second switching device 162 to the blower motor 115 as depicted at process step 315. In an embodiment the first switching device 164 is the switching device 164, which may include a semiconductor switching device such as a transistor, FET, MOSFET, IGBT and the like. Similarly, while in the described embodiment the second switching device 162 is the relay/contactor 162 it could also be a semiconductor switching device and the like as described herein.

Continuing with the method 300, at process step 320 a request to engage the blower system 130 and more specifically, the motor 115 is received. In an embodiment, the request to engage the blower 130 is based on a call for heating or cooling by the HVAC system 100. To initiate the soft starting of the motor 115, the first switching device 164 is commanded with a PWM command signal 165 that operates to apply a pulse of DC power to the motor 115 with an increasing duty cycle over a selected duration. Simultaneously, the gas ignition controller 101 and/or air handler controller 110 ensures that the second switching device 162 is disabled and passes no current to the motor 115 as depicted at process step 325. At process step 330, following the selected duration, the motor 115 should be operating at or near full speed. At this time, and the gas ignition controller 101 disables the first switching device 164 and enables the second switching device 162 as depicted at process step 330. The second switching device 162 operably connects full voltage of the DC power source 112 to the motor 115 to operate the motor 115 at full speed. The motor 115 is operated at the full voltage of the power source 112 for the duration of the call for heat or cooling as described herein. Finally optionally as described previously herein, once the call for heating or cooling has been satisfied, and the operation of the blower 130 is no longer required, optionally the method further includes a deceleration step 335 where once again the first switching devices 164 is connected and engaged. In this instance, a PWM scheme with a decreasing duty cycle is employed and applied to the first switching device 164 to decelerate the motor 115 in at a defined rate over another selected duration. The motor speed may, but need not be measured with a sensor internal to the motor 115, or for sensorless applications computed from the motor parameters using known techniques. However, other sensors and techniques may be employed to determine the motor speed. In some embodiments external measurements are made to determine the motor speed when commanded for some applications.

The technical effects and benefits of embodiments relate to an HVAC system include a system control unit or user device for implementing an internal compensation algorithm to determine operating parameters for an air handler system. The algorithm is used to determine the air handler system operating parameters to provide for a low soft start for the blower motor.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for soft start of a blower motor in a heating, ventilation, and cooling (HVAC) system, the method comprising:
operably connecting a first switching device with the motor; the first switching device operably connected to a DC power source and configured to direct power from the DC power source to the motor;
operably connecting a second switching device with the motor, the second switching device operably connected to the DC power source and configured to direct power from the DC power source to the motor;
receiving a request to engage the motor associated with an operation of the HVAC system;
commanding the first switching device with a first pulse width modulation (PWM) signal for a first selected duration, while ensuring the second switching device is disengaged, the commanding the first switching device with the first PWM signal comprising applying the first PWM signal to the first switching device causing the first switching device to activate at a selected duty cycle of the first PWM signal; and
after the first selected duration, enabling the second switching device and disengaging the first switching device.

2. The method of claim 1, further comprising:
receiving a request to disengage the motor;
disengaging the second switching device; and
commanding the first switching device with a second PWM signal for a second selected duration.

3. The method of claim 2, wherein the second PWM signal is operable to cause the first switching device to decelerate the motor over the second selected duration.

4. The method of claim 2, wherein the first selected duration is based on at least one of an amount of power dissipated in the first switching device, a thermal property of the first switching device, and an operating characteristic of the motor.

5. The method of claim 4, wherein the first selected duration is selected to ensure start-up of the motor without exceeding the thermal property of the first switching device for the power dissipated in the first switching device.

6. The method of claim 1, wherein the first PWM signal is operable to cause the first switching device to accelerate the motor over the selected duration.

7. The method of claim 1, wherein the request is based on a call for heating or cooling in the HVAC system.

8. The method of claim 1, wherein the first selected duration is based on at least one of an amount of power dissipated in the first switching device, a thermal properties of the first switching device, and an operating characteristic of the motor.

9. The method of claim 1, wherein the first switching device is a semiconductor device and the second switching device is an electromechanical device.

10. The method of claim 9, wherein the first switching device is a MOSFET and the second switching device is a relay.

11. A system for soft start of a blower and a motor in a heating, ventilation, and cooling (HVAC) system including an air handler with a blower and a motor , comprising:
a first switching device in operable communication with the motor; the first switching device operably connected to a DC power source and configured to direct power from the DC power source to the motor;
a second switching device operably connected with the motor, the second switching device operably connected to the DC power source and configured to direct DC power from the DC power source to the motor; and
a controller in operable communication with the first switching device and the second switching device, the controller configured to execute a method for soft starting of the motor comprising:
receiving a request to engage the motor associated with an operation of the HVAC system;
commanding the first switching device with a first pulse width modulation (PWM) signal for a first selected duration, while ensuring the second switching device is disengaged, the commanding the first switching device with the first PWM signal comprising applying the first PWM signal to the first switching device causing the first switching device to activate at a selected duty cycle of the first PWM signal; and
after the first selected duration, enabling the second switching device and disengaging the first switching device.

12. (canceled)

13. The system of claim 11, further comprising the controller:
receiving a request to disengage the motor;
disengaging the second switching device; and
commanding the first switching device with a second PWM signal for a second selected duration.

14. The system of claim 13, wherein the second PWM signal is operable to cause the first switching device to decelerate the motor over the second selected duration.

15. The system of claim 11, wherein the first selected duration is based on at least one of an amount of power dissipated in the first switching device, a thermal properties of the first switching device, and an operating characteristic of the motor.

16. The system of claim 11, wherein the first selected duration is selected to ensure start-up of the motor without exceeding the thermal properties of the first switching device for the power dissipated in the first switching device.

17. The system of claim 11, wherein the first PWM signal is operable to cause the first switching device to accelerate the motor over the selected duration.

18. The system of claim 11, wherein the request is based on a call for heating or cooling in the HVAC system.

19. The system of claim 11, wherein the first selected duration is based on at least one of an amount of power dissipated in the first switching device, a thermal properties of the first switching device, and an operating characteristic of the motor.

20. The system of claim 11, wherein the first switching device is a semiconductor device and the second switching device is at least one of a semiconductor device and an electromechanical device.

21. The system of claim 19, wherein the first switching device is a MOSFET and the second switching device is a relay.
